(19) United States
(12) Patent Application Publication
(10) Pub. No.: US 2014/0144695 A1
(43) Pub. Date: May 29, 2014

(54) Systems and Methods for Coupling a Power Cable to a Downhole Motor Using a Penetrator

(71) Applicant: Baker Hughes Incorporated, Houston, TX (US)

(72) Inventors: Michael R. Rumbaugh, Tulsa, OK (US); Jeffrey G. Frey, Broken Arrow, OK (US); Ryan P. Semple, Owasso, OK (US)

(73) Assignee: Baker Hughes Incorporated, Houston, TX (US)

(21) Appl. No.: 14/074,852

(22) Filed: Nov. 8, 2013

Related U.S. Application Data
(60) Provisional application No. 61/729,822, filed on Nov. 26, 2012.

(51) Int. Cl. H01R 13/533; H01R 43/00

(52) U.S. Cl. CPC H01R 13/533; H01R 43/00
USPC 174/70 R; 29/592.1

(57) ABSTRACT

Systems and methods for providing power to downhole equipment, where an electrical penetrator is installed through the housing of the equipment to provide a high pressure seal between the interior and exterior of the equipment's housing. In one embodiment, the body of the electrical penetrator includes a substantially rigid outer body, an electrically insulating inner body positioned within the outer body, and a set of electrical conductors that extend through the electrically insulating (e.g., glass or ceramic) inner body. Each of the conductors extends through the penetrator body. The inner body is sealed against both the conductors and the outer body by bonding them together, for example. The ends of the conductors which extend into the housing are connected to the motor or other equipment, while the ends of the conductors which to the exterior of the housing are connected to a power cable.

### CROSS-REFERENCE TO RELATED APPLICATIONS

This application claims the benefit of U.S. Provisional Patent Application 61/729,822, filed Nov. 26, 2012, which is incorporated by reference as if set forth herein in its entirety.

### BACKGROUND

1. Field of the Invention

The invention relates generally to downhole electric equipment, and more particularly to systems and methods for providing an improved coupling between a power cable and a downhole electric motor by using a penetrator to convey electrical power through the motor housing.

2. Related Art

Electric submersible pump (ESP) systems are commonly positioned deep within subterranean wells and are used to pump fluids from the wells. Power suitable to drive the ESP systems is produced at the surface of the wells and is delivered to the ESP systems via power cables that extend into the wells. The power cables typically have one or more electrical junctions, such as splices to motor leads and “pothead” connectors that couple the power cable to the downhole equipment (e.g., an ESP motor).

The environment downhole in the wells may be very harsh. For instance, the pressure may be very high (and subject to fluctuations), the temperature may be several hundred degrees, the fluids in the wells may be corrosive, and particles in the fluids may be abrasive. These conditions can cause the components of an ESP system to degrade and possibly fail, thereby shortening the useful life of the ESP system.

One of the potential points of failure is the pothead connector that couples the power cable to the motor of the ESP system. The cable is physically secured to the pothead connector, which is then secured (e.g., bolted) to the housing of the motor. A gasket or seal ring is provided between the pothead connector and the motor housing to seal the junction and isolate the interior of the motor from the well environment. Because downhole pressures are increasing, there are increasing pressure differentials across the pothead seal which present an increased risk that this seal will fail. Such a failure could allow contaminants from the well environment to leak into the motor and potentially cause the motor itself to fail.

It would therefore be desirable to provide systems and methods for providing a seal between the motor housing and the conductors that carry power to the motor, where the seal can withstand the increased pressure differentials that are present in downhole environments.

### SUMMARY OF THE INVENTION

This disclosure is directed to systems and methods for providing power to downhole equipment that solve one or more of the problems discussed above. In one particular embodiment, an apparatus includes a piece of downhole electric equipment having a housing and an electrical penetrator. One or more components of the piece of downhole electric equipment are contained within an interior of the housing. The electrical penetrator is installed in the housing so that a first end of the electrical penetrator extends into the interior of the housing and a second end of the electrical penetrator extends to an exterior of the housing. The electrical penetrator includes a penetrator body having a substantially rigid outer body and an electrically insulating inner body that is positioned within the outer body. The inner body may be, for example, glass or ceramic. The electrical penetrator has a set of electrical conductors that extend through the electrically insulating inner body. Each of the conductors has a first end that extends into the interior of the housing and a second end that extends to an exterior of the housing. Each of the electrical conductors is electrically insulated from the outer body by the electrically insulating inner body, and is bonded to the inner body. The electrical conductors may each have a layer of electrical insulation between the metal conductor and the inner body of the penetrator. The inner body is also bonded to the outer body. The first end of each of the conductors is electrically coupled to a corresponding power conductor of the downhole electric equipment. The second end of each of the conductors can then be coupled to a power source external to the housing of the downhole equipment. In one embodiment, the downhole electric equipment comprises a motor of an ESP. The conductors of the electrical penetrator extend from the interior of the ESP motor to a power cable at the exterior of the motor. The power cable couples the motor to a power source such as a variable speed drive at the surface of a well in which the ESP is installed.

An alternative embodiment comprises a method for providing power to a piece of downhole equipment. The method includes providing an electrical penetrator, where the penetrator has a substantially rigid outer body, an electrically insulating inner body positioned within the outer body, and a set of electrical conductors that extend through the penetrator. The conductors form “pig tails” at opposite ends of the electrical penetrator. Each of the electrical conductors is electrically insulated from the outer body by the electrically insulating inner body. The electrical conductors are bonded to the electrically insulating inner body, and the inner body is bonded to the outer body. The electrical penetrator is installed in a housing of the downhole equipment, and is sealed against the housing. A first set of the pig tails at the interior of the housing are connected to corresponding conductors of the downhole electric equipment. The motor housing is then sealed to provide a sealed enclosure for the downhole equipment. The ends of the conductors that extend to the exterior of the housing can be connected to corresponding conductors of a power cable.

Another alternative embodiment comprises an electrical penetrator that is used to provide power to a piece of downhole equipment. In this embodiment, the penetrator includes a penetrator body having a substantially rigid (e.g., metal) outer body, an electrically insulating inner body positioned within the outer body, and a set of electrical conductors that extend through the electrically insulating inner body. The electrically insulating inner body may be made, for example, of glass or ceramic. Each of the conductors has a first end that extends from a first end of the penetrator body and a second end that extends from a second end of the penetrator body. Each of the electrical conductors is electrically insulated from the outer body by the electrically insulating inner body. The electrical conductors may each have a separate layer of electrical insulation as well. Each of the electrical conductors is sealed against the inner body by, for example, being bonded to it. Similarly, the electrically insulating inner body is sealed against the outer body (e.g., by bonding them to each other).

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary ESP system in accordance with one embodiment.

FIG. 2 is a functional block diagram illustrating the use of motor penetrator to couple a power cable to the top of an ESP motor.

FIGS. 3 and 4 are diagrams illustrating the use of a motor penetrator connector to couple a power cable to the top of an ESP motor in accordance with one embodiment.

FIG. 5 is a flow diagram illustrating a method in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as would be understood by persons skilled in the art of the invention.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for electrical penetration of a motor, such as may be used in an ESP system. “electrical penetration” refers to the transmission of electrical power from a source (e.g., power cable) external to the motor to the interior of the motor, where it can drive the motor. The present systems and methods use a penetrator, which is a device that penetrates and extends through the motor housing, but can be sealed against the housing so that a relatively large pressure differential between the interior of the housing and the exterior of the housing. The motor penetrator can therefore withstand a much greater pressure differential than a conventional pothead connector, which can fail under a large pressure differential.

The motor penetrator has one or more conductors that extend through a penetrator body. In one embodiment, three conductors are provided to transmit three-phase power through the motor housing. Each conductor has a portion that extends into the motor housing, where it can be connected to the motor windings, and a portion that extends outward to the exterior of the motor housing, where it can be connected to the power cable. The conductors thereby provide means to transmit electrical power from the power cable to the motor. The motor penetrator can be installed in the factory under clean, controlled conditions, where the integrity of the electrical connections and seals can be easily tested and any failures quickly resolved. Additionally, since only the external portions of the penetrator conductors have to be spliced to the power cable in the field, installation of the motor requires less time and reduces associated costs.

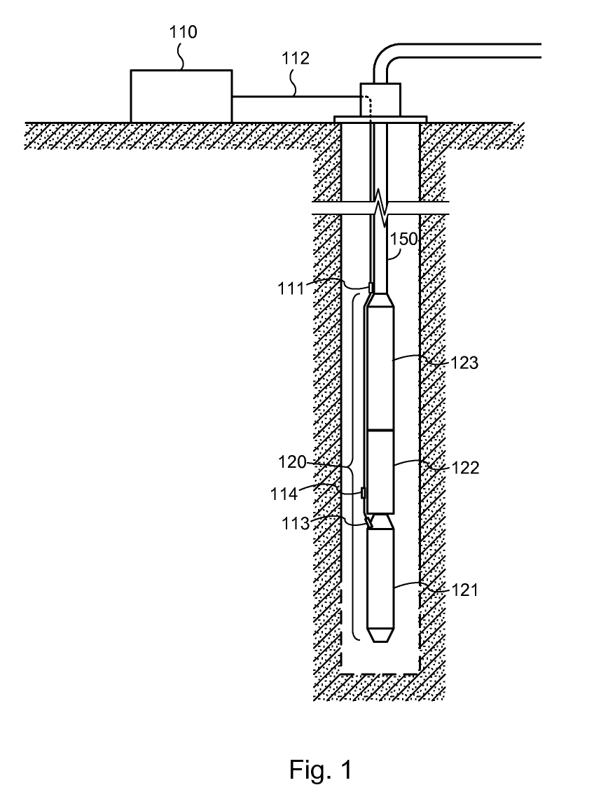

Referring to FIG. 1, a diagram illustrating an exemplary artificial lift system in which one embodiment of the present invention may be implemented is shown. In this embodiment, an ESP system is installed in a well for the purpose of producing oil, gas or other fluids. An ESP 120 is coupled to the end of tubing string 150, and the ESP and tubing string are lowered into the wellbore to position the ESP in a producing portion of the well (as indicated by the dashed lines at the bottom of the wellbore). Surface equipment that includes a drive system 110 is positioned at the surface of the well. Drive system 110 is coupled to ESP 120 by power cable 112, which runs down the wellbore along tubing string 150. Tubing string 150 and power cable 112 may range from less than one thousand feet in a shallow well, to many thousands of feet in a deeper well.

ESP 120 includes a motor section 121, seal section 122, and pump section 123. ESP 120 may include various other components which will not be described in detail here because they are well known in the art and are not important to a discussion of the invention. Motor section 121 is operated to drive pump section 123, thereby pumping the oil or other fluid through the tubing string and out of the well. Drive system 110 produces power (e.g., three-phase AC power) that is suitable to drive motor section 121. This output power is provided to motor section 121 via power cable 112.

Power cable 112 extends from drive system 110 to ESP 120. In this embodiment, power cable 112 includes two components: a primary cable component and a motor lead component. The primary cable extends downward along the tubing string from the drive unit at the surface of the well to a point near the ESP. At this point (typically 10-50 feet above the ESP), the primary cable is connected to the motor lead extension (MLE) by a splice 111. The motor lead extends from the primary cable to the motor, and is connected to the motor by a second splice 114 to a set of pigtail leads extending from the upper end of a penetrator 113. The conductors of the pigtail leads extend through the body of penetrator 113 to form another set of pigtail leads in the interior of the motor housing. The second set of pigtail leads are coupled to the internal wiring of the motor.

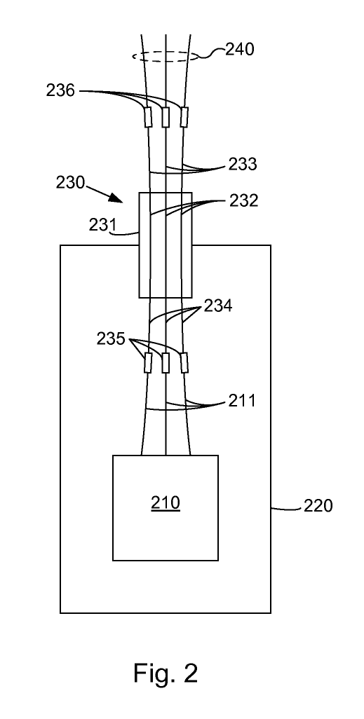

Referring to FIG. 2, a functional block diagram illustrating a penetrator coupled to a motor in accordance with one embodiment is shown. In this embodiment, a set of motor windings 210 is in closed within a motor housing 220. A penetrator 230 is installed in motor housing 220. Penetrator 230 may, for example, be installed in a motor head portion of the motor housing. Penetrator 230 has a body 231 with a set of insulated conductors 232 extending through the body. An upper end of penetrator body 231 extends outward from motor housing 220, while a lower portion of the penetrator body extends into the interior of the motor housing. A portion of each of conductors 232 extends from each end of penetrator body to form leads that may be referred to as “pig tails”. A first set of pig tails 233 extends outward from the upper end of penetrator body 231, while a second set of pig tails 234 extends into the interior of the motor housing from the lower end of the penetrator body. Pig tails 233 are connected to the conductors of power cable 240 by splices 236, and pig tails 234 are connected to the motor winding lead wires by splices 235, thereby coupling the power from the cable to the motor.

A seal is formed between penetrator body 231 and motor housing 220. Similarly, a seal is formed between penetrator body 231 and each of insulated conductors 232. The seals isolate the interior of the motor housing from the exterior of the housing. The penetrator body may be manufactured using metals, ceramics, fluoropolymers, PEEK, or other materials that are suitable for the well environment in which the system will be used. The seal between the penetrator body and the motor housing may, for example, be a metal-to-metal seal, or may use elastomeric or non-elastomeric sealing elements. The seal between the penetrator body and the conductors may, for example, use ceramics, fluoropolymers, PEEK, or other insulation materials.

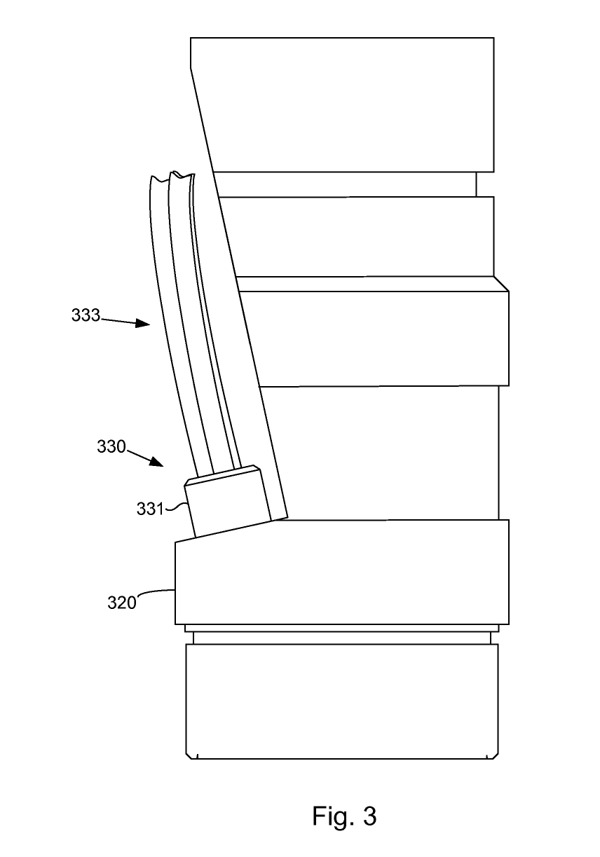

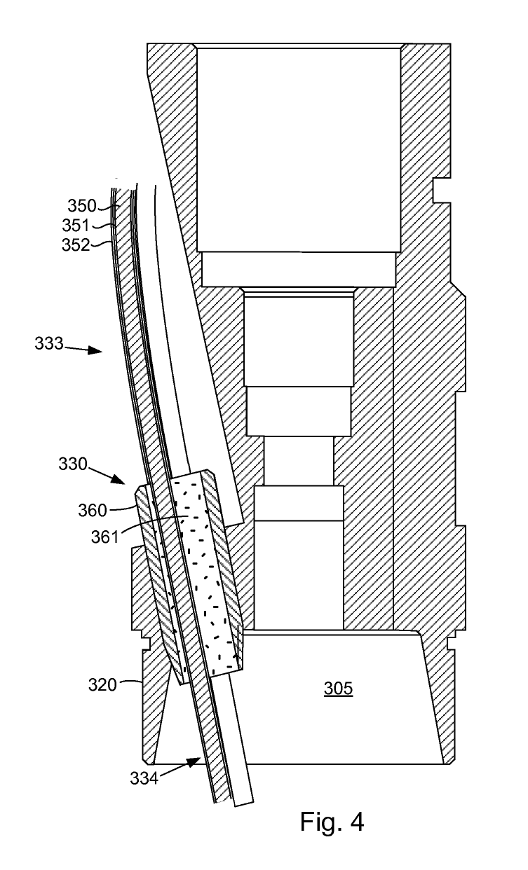

Referring to FIGS. 3 and 4, more detailed views of a penetrator device installed in a motor housing are shown. FIG. 3 is a side view of the assembly, while FIG. 4 is a cross-sectional view of the assembly.

Referring to FIG. 3, motor penetrator 330 is installed in the motor head 320 of an electric motor suitable for use in an ESP. Penetrator 330 is installed in essentially the same position as a pothead connector in a conventional ESP motor. The body 331 of penetrator 330 extends outward from motor head 320. A set of pig tail leads 333 extends upward from penetrator body 331.

Referring to FIG. 4, it can be seen that the penetrator body extends through motor head 320 from an interior 305 of the motor head to the exterior of the motor head. In this figure the penetrator body is depicted as having an outer body 360 and an inner body 361. The outer body may be metal, ceramic or other suitable material that can form a seal against the material of motor head 320. Inner body 361 may be an insulating material such as a ceramic, fluoropolymer, or PEEK that can form a seal against the insulated conductors. Separate components may alternatively be used to provide a seal between the insulated conductors and the penetrator body. The insulated conductors are depicted in this figure as having a metal conductor 350 encased in an electrically insulating layer 351. In this embodiment, each of the insulated conductors also has a layer of protective armor 352. The protective armor could alternatively be provided around the collective group of conductors. The insulated conductors extend upward, to the exterior of motor head 320, to form pig tails 333, and extend downward, into the interior of the motor head, to form pig tails 334. The pig tails can be connected to the respective cable conductors or motor leads using hand splices, pin connections, or other appropriate means. The penetrator thereby provides a coupling between the power cable and motor that is junctionless at the motor housing.

It should be noted that the structure of the penetrator is depicted generically in FIG. 4. The specific structure of a particular embodiment of the motor penetrator may vary from this generic structure, and may include features that are not shown here. Numerous exemplary penetrator structures (e.g., as used in wellhead penetrators) are known in the art and these structures may be suitable for implementation in various embodiments of the present invention. The penetrators may be used for sets of conductors (e.g., the three conductors used to transmit three-phase power), or they may be used for individual conductors.

The use of a motor penetrator to couple the power cable to the leads of the motor may have a number of advantages over the prior art. For instance, pressures in well environments are increasing and, while seals in ESP systems are intended to compensate for the pressure differentials, they may not be able to equalize the increased pressure differentials as quickly as desired. This may result in the failure conventional pothead connectors, which are simply plugged into the motor head and bolted in place over a gasket or other simple type of seal. A motor penetrator is capable of withstanding much greater pressure differentials, and is therefore much less likely to experience a seal failure that could allow contaminants to be introduced into the motor, which could in turn lead to a failure of the motor.

Another advantage of the motor penetrator is that the penetrator can be installed in a clean factory environment and tested in the factory to ensure the integrity of the seal and the electrical connections. When a pothead connector is used to couple the power cable to the motor, it is typically necessary to connect the wires of the motor windings to leads that are then coupled to a connector (at the I-block) in the motor housing. When a motor penetrator is used, the wires of the motor windings can be directly connected to the pig tails of the penetrator, so that there is one less connection within the motor housing. Similarly, external to the motor housing, the pig tails of the penetrator can be spliced directly to the power cable or MLE's, so there is one less connection than when a pothead connector has to be spliced to the power cable or MLE's, and then plugged into the motor head. The reduced number of connections reduces the time required to make the connections in the field, and consequently reduces the rig time and costs associated with making these connections.

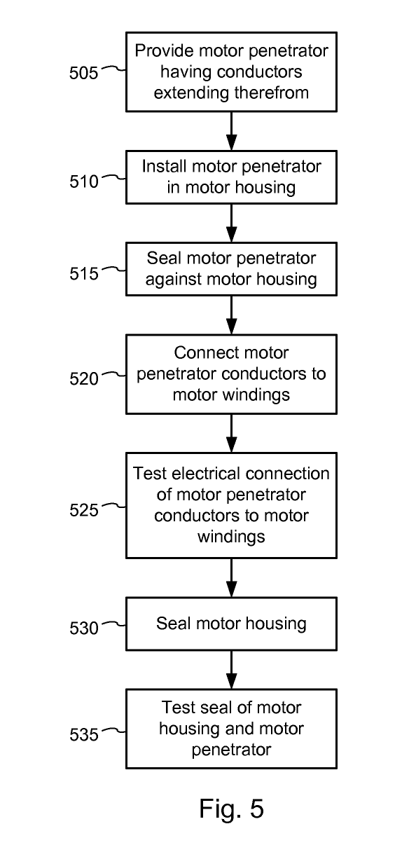

Alternative embodiments of the invention may include methods for providing electrical connections between the windings of a downhole motor and the exterior of the motor's housing. One exemplary method is illustrated in the flow diagram of FIG. 5. In this method, a motor penetrator having a set of conductors extending therethrough (i.e., pig tails) is provided (505). The motor penetrator is installed in the housing of the motor (510) so that a first set of the pig tails extends into the interior of the motor housing and a second set of the pig tails extends from the penetrator body to the exterior of the housing. The body of the motor penetrator is then sealed against the motor housing (515). This may consist simply of positioning the penetrator body within an aperture in the motor housing (e.g., when employing a metal-to-metal seal), or it may involve steps to bond or otherwise seal the penetrator body to the housing (e.g., when employing a glass-to-metal seal). The interior set of pig tails can then be connected to the motor winding leads (520) using splices, connectors or other suitable means. The electrical connections between the motor penetrator conductors and the motor windings are then tested (525). If the electrical connections are good, the motor housing can be sealed (535). This may, for example, consist of installing the motor head on the motor. Finally, the seals of the motor (e.g., between the motor penetrator and the housing) can be tested (535). If the seals are good, the motor can be shipped to a well location, where it can be installed in a well.

It should be noted that the benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as described above.

What is claimed is:

1. An apparatus comprising:
a piece of downhole electric equipment having a housing, wherein one or more components of the piece of downhole electric equipment are contained within an interior of the housing; and
an electrical penetrator for a piece of downhole equipment, wherein the electrical penetrator is installed in the housing and wherein a first end of the electrical penetrator extends into the interior of the housing and a second end of the electrical penetrator extends to an exterior of the housing;
wherein the electrical penetrator includes
a penetrator body having a first end and a second end, wherein the penetrator body includes a substantially rigid outer body and an electrically insulating inner body positioned within the outer body,
one or more electrical conductors that extend through the electrically insulating inner body, wherein each of the conductors has a first end that extends from the first end of the penetrator body and a second end that extends from the second end of the penetrator body,
wherein each of the electrical conductors is electrically insulated from the outer body by the electrically insulating inner body,
wherein each of the electrical conductors is bonded to the electrically insulating inner body,
wherein the electrically insulating inner body is bonded to the outer body; and
wherein the first end of each of the conductors extending from the first end of the penetrator body into the interior of the housing is electrically coupled to a corresponding power conductor of the piece of downhole electric equipment.

2. The apparatus of claim 1, wherein the piece of downhole electric equipment comprises a motor of an electric submersible pump.

3. The apparatus of claim 1, wherein the second end of each of the conductors extending from the second end of the penetrator body to the exterior of the housing is electrically coupled to a corresponding conductor of a power cable that extends to a power source at the surface of a well in which the piece of downhole electric equipment is installed.

4. The apparatus of claim 1, wherein the electrically insulating inner body comprises glass.

5. The apparatus of claim 1, wherein the electrically insulating inner body comprises ceramic.

6. The apparatus of claim 1, wherein the outer body comprises metal, wherein the electrically insulating inner body comprises glass, and wherein the glass of the electrically insulating inner body is bonded to the metal of the outer body.

7. The apparatus of claim 1, wherein each of the electrical conductors includes a metal conducting portion and a layer of electrical insulation, wherein the layer of electrical insulation is bonded to the electrically insulating inner body.

8. A method for providing power to a piece of downhole equipment, the method comprising:
providing an electrical penetrator, wherein the electrical penetrator includes
a substantially rigid outer body,
an electrically insulating inner body positioned within the outer body,
one or more electrical conductors that extend through the electrically insulating inner body and form pig tails at opposite ends of the electrical penetrator,
wherein each of the electrical conductors is electrically insulated from the outer body by the electrically insulating inner body, wherein each of the electrical conductors is bonded to the electrically insulating inner body, and wherein the electrically insulating inner body is bonded to the outer body;
installing the electrical penetrator in a housing of the piece of downhole equipment, wherein the outer body of the electrical penetrator is sealed against the housing;
connecting a first set of the pig tails at the interior of the housing to corresponding conductors of the piece of downhole electric equipment;
sealing the motor housing and thereby providing a sealed enclosure for the piece of downhole equipment; and
connecting a second set of the pig tails at the exterior of the housing to corresponding conductors of a power cable.

9. The method of claim 8, wherein installing the electrical penetrator in the housing of the piece of downhole equipment comprises installing the electrical penetrator in the housing of an electric submersible pump motor.

10. The method of claim 8, wherein the electrically insulating inner body of the electrical penetrator comprises glass.

11. The method of claim 8, wherein the electrically insulating inner body of the electrical penetrator comprises ceramic.

12. The method of claim 8, wherein the outer body comprises metal, wherein the electrically insulating inner body comprises glass, and wherein the glass of the electrically insulating inner body is bonded to the metal of the outer body.

13. The method of claim 8, wherein each of the electrical conductors includes a metal conducting portion and a layer of electrical insulation, wherein the layer of electrical insulation is bonded to the electrically insulating inner body.

14. An electrical penetrator for a piece of downhole equipment, the penetrator comprising:
a penetrator body having a first end and a second end, wherein the penetrator body includes a substantially rigid outer body and an electrically insulating inner body positioned within the outer body; and
one or more electrical conductors that extend through the electrically insulating inner body, wherein each of the conductors has a first end that extends from the first end of the penetrator body and a second end that extends from the second end of the penetrator body;
wherein each of the electrical conductors is electrically insulated from the outer body by the electrically insulating inner body;
wherein each of the electrical conductors is bonded to the electrically insulating inner body; and
wherein the electrically insulating inner body is bonded to the outer body.

15. The electrical penetrator of claim 14, wherein the electrically insulating inner body comprises glass.

16. The electrical penetrator of claim 14, wherein the electrically insulating inner body comprises ceramic.

17. The electrical penetrator of claim 14, wherein the outer body comprises metal, wherein the electrically insulating inner body comprises glass, and wherein the glass of the electrically insulating inner body is bonded to the metal of the outer body.

18. The electrical penetrator of claim 14, wherein each of the electrical conductors includes a metal conducting portion and a layer of electrical insulation, wherein the layer of electrical insulation is bonded to the electrically insulating inner body.
